(19) United States
(12) Patent Application Publication
(10) Pub. No.: US 2025/0095290 A1
(43) Pub. Date: Mar. 20, 2025

(54) SYSTEM FOR MITIGATING CONVERGENCE INSUFFICIENCY IN VIRTUAL REALITY DISPLAYS

(71) Applicant: Dark Arts Software LLC, Seattle, WA (US)

(72) Inventors: Patrick John Ascolese, Seattle, WA (US); Sabin Timalsena, Newcastle, WA (US)

(21) Appl. No.: 18/886,928

(22) Filed: Sep. 16, 2024

Related U.S. Application Data
(60) Provisional application No. 63/539,064, filed on Sep. 18, 2023.

(51) Int. Cl. G06T 17/00; G06T 7/70; H04N 5/74; H04N 13/344

(52) U.S. Cl. CPC G06T 17/00; G06T 7/70; H04N 5/74; H04N 13/344

(57) ABSTRACT

A distance from a viewpoint of a virtual camera to a projection surface in a virtual environment at which objects projected on the projection surface are in clearer focus for a user than at another distance from the viewpoint of the virtual camera is determined. A location of an object in the virtual environment is obtained. An image that includes the object is projected onto the projection surface project based on the distance and the location.

### CROSS-REFERENCE TO RELATED APPLICATION

This application claims the benefit of U.S. Provisional Application No. 63/539,064, filed Sep. 18, 2023, entitled “SYSTEM FOR IMPROVING THE VISUAL EXPERIENCE OF VIRTUAL REALITY GLASSES,” the disclosure of which is herein incorporated by reference in its entirety.

### BACKGROUND

Modern Virtual Reality headsets generally feature two physical video displays, one for each eye of the wearer. This feature allows real-time, three-dimensional (3D) applications to produce a unique view for each eye, known as stereoscopic rendering. Realtime 3D virtual reality (VR) applications generally use left eye and right eye virtual cameras, where each virtual camera individually “sees” into a virtual environment from a slightly different perspective of the other victual camera and accordingly captures a slightly different image of the virtual environment, similar to the way a human's left and right eye each receive unique views into the real world. The captured images are displayed on the corresponding video displays, and consequently, because each of the user's eyes receives a slightly different image into the virtual environment, the user must focus and fixate their eyes appropriately to clearly see nearby objects versus far away objects. Having to focus and fixate on the objects in the display gives users of real time VR environments a sense of depth similar to viewing the environment in real life. In this way, VR environments differ from traditional video games and films, which produce a monoscopic view into the virtual 3D environment and present this image to the user via a computer monitor, television (TV) screen or projector, which effectively function as a rectangular “window” into the simulated environment.

Virtual Reality's stereoscopic rendering presents numerous problems not found in traditional 3D video games or films development. These problems are described below.

### 1. The Vergence Problem

Stereoscopic Virtual Reality headsets present eyeglass wearers with challenges. In order to properly perceive images in virtual reality, two mechanisms must work correctly—accommodation and vergence. Accommodation is the mechanism with which the eyes adjust focus and produce a clear image in the retina. Vergence is the mechanism by which the two eyes independently rotate outward/inward to fixate on objects and achieve binocular fusion. Like when viewing the real world, some find it difficult to obtain proper focus and/or fixate on the rendered image. Wearing eyeglasses within VR headsets does help mitigate the problem of obtaining correct focus on the virtual display, but it does not alleviate the discomfort related to fixating the eyes to perceive two images of a rendered object as single, and when adjusting fixation from close objects to distant objects in the rendering. Binocular fusion also becomes harder when the distance between the lenses in the headset do not match the inter-pupillary distance of the viewer's eyes, which will vary based on where the eyes are converged. On top of all this, there is a problem unique to stereoscopic renderings known as the “vergence-accommodation conflict,” where unlike in the real world, the eyes have to focus and fixate at different distances in VR. This type of unnatural eye fixation causes additional discomfort.

In an effort to be ever more lightweight, smaller headsets have been produced. However, smaller headsets do not make great accommodations for eyeglass wearers. Glasses “spacers” and prescription headset lenses represent the current offering, neither are ideal solutions. To reduce discomfort related to binocular fusion, some VR headsets allow for adjusting the distance between the lenses to try and match the viewer's interpupillary distance. However, the inter-pupillary distance may not be measured/adjusted accurately in practice, and available offerings also do not cover the entire spectrum of inter-pupillary distance. These fixed adjustments still do not account for the changes in inter-pupillary distance during viewing. Finally, adjusting vergence is a process that takes a nontrivial amount of eye effort and time, which can be discomforting to the viewer if there are many rapidly moving objects in the scene, as is common in games.

### 2. The Post-Processing Problem

In traditional 3D games and films, “post-processing” (sometimes referred to as “screen space effects”) are essentially “full screen filters” applied to a frame after the scene is captured and rendered by the camera, but before it is presented to the viewer. Traditional live action films are captured using a single physical monoscopic camera, while traditional 3D video games and computer-generated (CG) animated films generally use a single virtual monoscopic camera to capture the virtual world. In both cases, the camera captures a rectangular image that is presented to the user, and the viewer has no control over where the user is looking within the virtual environment. Traditional game and film content creators have essentially unlimited freedom to control the “gaze direction” and “focal point” of the viewer into the simulated 3D spaces they create. The same is often true for “real time” 3D games and simulations because the user is not necessarily in control of the virtual camera at all times. Any given frame of traditional film or video game displays only the content the creator explicitly wants the user to see. Additional techniques such as “depth of field” (DoF) are often invoked to force viewers to focus on objects in the foreground or background of any given frame. For example, objects in the background may be “blurred” to encourage users to focus on characters or objects in the foreground, or vice versa. Physical cameras, like the human eye, can change the focal point and focal depth of the scene being viewed by changing by adjusting physical settings and muscles respectively; for example, in the real world, DoF can be applied directly to a frame at the moment the scene is captured. Virtual cameras, like the environments they sample, are computer-generated mathematical constructs that have no inherent physical characteristics, so all features emulating those of real-world cameras must be deliberately applied. There are many other real world visual effects such that virtual cameras simply do not generate automatically, such as motion blur, lens flare and light bloom to name a few. In games and CG films these effects are generally applied as a “post-process” after the 3D scene has been captured and projected onto a two-dimensional (2D) surface, but before the final scene is presented. Post-processing is generally recognized as “expensive” to do in real time applications because it often requires updating each pixel of the output image (of which there are millions), potentially multiple times depending on how many post-processing processing effects are being layered in for a given frame, double this for VR as there is an individual image generated for each eye. It is extremely important that real-time VR applications run at a high and consistent framerate experience or risk causing discomfort, when the frame rate falls below a minimum frequency input lag is perceivable to many users, and when the framerate “hiccups” or “hangs” users can experience severe motion sickness in some case, as their visual stimuli are completely disconnected from their physical actions. 60 Hz is generally considered the absolute minimum acceptable frame rate for VR, and higher is better. This minimum frame rate must be achieved for two virtual cameras for each frame, contrast this with traditional PC or console gaming where a single camera 30 Hz frame rate experience is still considered acceptable. Some VR headset manufacturers even recommend that developers forego all post-processing due to adverse performance impact.

Discounting the performance implications, post-processing in VR presents additional challenges not found in traditional real-time games. Many post-processing and “screen space” effects that work well in traditional games do not work properly in VR due to the stereoscopic nature of the rendering. One example is cartoon or comic book style rendering effects. It is relatively easy to create traditional video games that believably immerse the player in a world that, while offering a full six degrees of freedom, truly looks and feels to the player like the action is taking place in a hand painted/drawn world. These types of effects are frequently accomplished by drawing object outlines and shading highlights directly onto objects after they have been captured and rendered onto the final 2D image but before they are presented to the users (i.e., during the post-processing step). These effects are often accomplished by finding the “edges” of 3D objects on the 2D image, which solve the angles and depth (distance) of various portions of the scene with respect to the virtual camera. In VR, given that there are two cameras, these types of effects often fail to deliver the intended experience of making the user feel immersed in a cartoon or comic book style world. Each virtual eye camera has a slightly different position and angle with respect to the virtual world, resulting in slightly different versions of the final effect being delivered to each eye during post-processing, which in the worst case can cause discomfort as the “shading” presented to each eye is noticeably different and in the best case simply present the user with a “bad” effect that hurts the sense of immersion and misses the developers intention. Some VR applications attempt to solve this problem in a few ways. Some applications present each eye's post-processing step with the same depth and/or angle data, as if both images were captured from a “center eye” point, given that the 3D image rendered for each is technically different this does not yield perfect results and the effect fails. Other applications apply these types of effects in “world space” (e.g., directly to the color of the object at the time it is initially rendered as a 3D object, which often limits the quality of the effect). Still images of both of these techniques often look excellent (as the still image was captured from a single eye camera), but when experiencing the effects in real time, both fail to meet their intent of making the user feel immersed in a comic book or cartoon, and instead make the user feel as though they are in a full 3D with a lighting model, unlike the embodiments described in the present disclosure below.

Post-processing effects that work well in traditional 2D media do not translate seamlessly to stereo VR. Examples include stylization effects like outline rendering, dithering, halftoning and painterly effects (e.g., watercolor/brush/pointillism). Many of these effects rely on detecting edges and sampling information from the rendered image, and such information is not consistent between the two renderings in a stereo VR setup. For example, when outline rendering is applied separately to a stereo image pair, the left eye will see outlines around slightly different parts of the same object compared to the right eye. Inconsistencies like these can lead to reduced presence or even break the illusion of depth.

Another example is the DoF effect that is used to create a “background blur” and also to guide the eye of the viewer towards a specific part of the scene as desired. Even if the DoF is adaptively changed in response to eye tracking, a small imprecision in the tracking can result in misalignment between the DoF effect and the user's intended focal point. Trying to use DoF effects in stereo VR as a tool to guide the user's eye towards specific elements or characters within a scene can lead to unnatural visual experiences, as it can conflict with the accommodation and depth cues provided by the stereo rendering. For instance, the user would be able to fixate on an object that is out of focus, while in real life the points of fixation and focus would be the same.

Furthermore, the performance implications of post-processing in stereo VR are significant. VR applications require high frame rates to maintain a smooth and comfortable experience. Applying complex post-processing effects to two separate views, however, puts heavy strain on system resources, potentially causing frame rate drops, stuttering, or latency issues.

Particle effects, commonly used to draw smoke, fire, dust, sparks, electricity, energy, and a myriad of other often “formless” and “layered” objects, are negatively impacted by VR's two camera model. Particles are often drawn in “world space” (e.g., onto flat cards in the 3D scene; these cards are transparent except for where the “particle” texture is drawn onto them). Fire, for example, is often rendered as a cluster of “fire particles” that are emitted from a specific area and controlled based on a particle simulation that controls their animation, size, lifetime, brightness and how they are rendered. In many cases the individual particles are rotated such that they always “face” the user's camera as they move around in the scene. Given there are two cameras in VR this presents the challenge of deciding whether particles should be reoriented in 3D for each eye before it is rendered, or if they should be pointed at a single center eye effect. Both solutions can yield visual artifacts revealing to the user that the particle is simply a “card” in space.

In view of the foregoing, a need exists for an improved Virtual Reality Rendering system that allows users to see virtual environments clearly in a way that does not impair binocular fusion. While prescription lenses alleviate the accommodation (focus) problem, they cannot mitigate problems related to convergence/binocular fusion. Further, rendering techniques are required that support traditional post-processing and “screen space” effects in immersive real time VR applications. The solution to both are variations on the same technology described in the present disclosure.

### BRIEF DESCRIPTION OF THE DRAWINGS

Various techniques will be described with reference to the drawings, in which:

FIGS. 1A-1B illustrate an example of a mitigation strategy to a vergence problem in accordance with an embodiment;

FIG. 2 illustrates an example of multi-convergence distance in accordance with an embodiment;

FIG. 3 illustrates an example of determining a convergence distance for a reprojection surface in accordance with an embodiment;

FIG. 4 is a flowchart that illustrates an example of a calibration process for determining a convergence distance in accordance with an embodiment;

FIG. 5 is a flowchart that illustrates an example of a process for improving visual experience with virtual reality displays in accordance with an embodiment; and

FIG. 6 illustrates a system in which various embodiments can be implemented.

### DETAILED DESCRIPTION

### 1. Solving the Convergence Problem

One of the principal ways the human binocular vision system focuses on an object is through a process called vergence. Wikipedia describes vergence as such: “When a creature with binocular vision looks at an object, the eyes must rotate around a vertical axis so that the projection of the image is in the center of the retina in both eyes. To look at an object closer by, the eyes rotate towards each other (convergence), while for an object farther away they rotate away from each other (divergence). Exaggerated convergence is called cross eyed viewing (focusing on the nose for example).” See Vergence, Wikipedia, https://en.wikipedia.org/wiki/Vergence (last visited Jul. 4, 2023). For many people with commonplace vision deficiencies there is generally a physical distance from their face at which they can focus on without discomfort, and refractive adjustments like wearing eyeglasses can help bring things into a comfortable focus distance. Once focus is obtained, one must further obtain “motor fusion” and “sensory fusion” in order to correctly perceive a stereoscopic image pair. Wikipedia describes these mechanisms as: “Motor fusion describes the vergence eye movements that rotate the eyes about the vertical axis. Sensory fusion is the psychological process of the visual system that creates a single image perceived by the brain.” See Binocular Summation, Wikipedia, https://en.wikipedia.org/wiki/Binocular summation, (last visited Jul. 4, 2023). Conditions that cause problems in these mechanisms compromise the ability of someone to experience VR comfortably. “Convergence insufficiency” is a common condition related to motor fusion in which the eyes cannot converge or sustain convergence at the desired point of fixation (e.g., when someone cannot turn their eyes inward enough when reading a book). Also, when VR content is rendered with incorrect inter-pupillary distance, it may require the viewer's eyes to converge or diverge more than usual and can introduce or exacerbate vergence related discomfort.

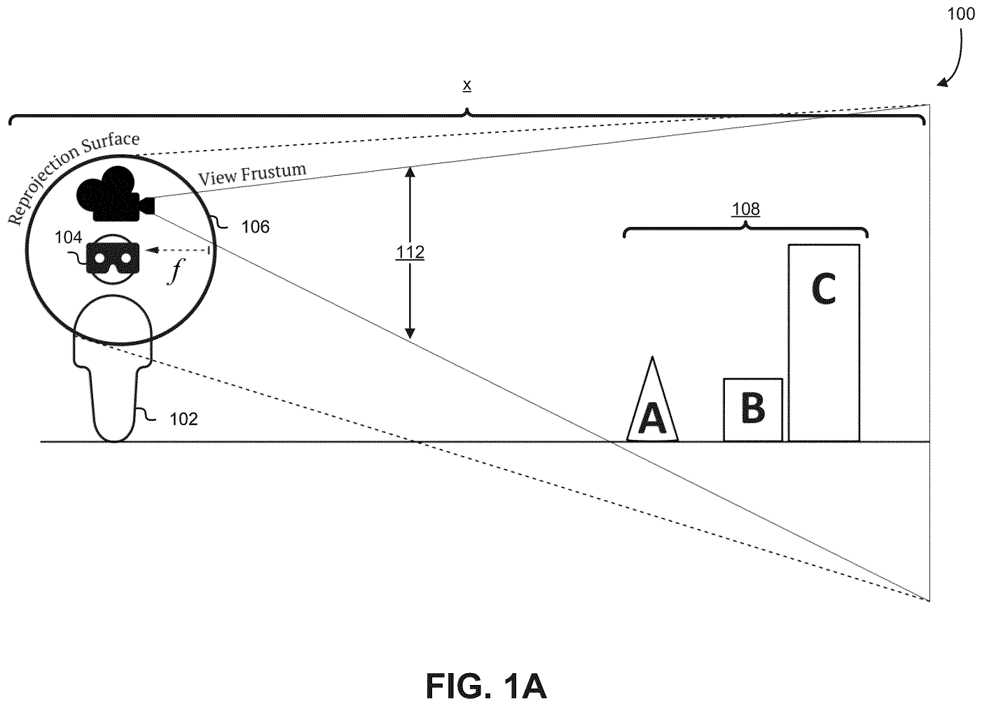

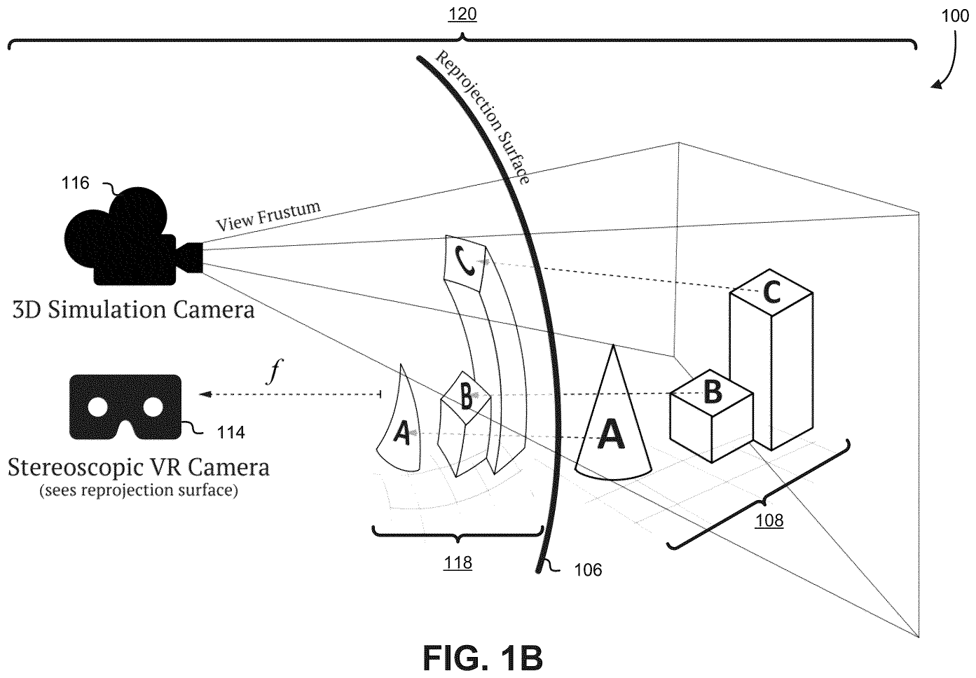

FIG. 1 illustrates a mitigation strategy to the vergence problem according to an embodiment 100 of the present disclosure. Specifically, FIG. 1 depicts a user 102 wearing a VR headset 104 viewing a reprojection surface 106 within the VR headset 104 that reprojects an image of objects 108 A, B, and C in a virtual environment 120 onto a reprojection surface 106. The mitigation strategy employed by the embodiment 100 involves presenting the entire real-time 3D environment 120 to the user 102 at a single convergence distance f they can see clearly without the need for adjusting the amount of “cross-eye” needed for near and far virtual objects. This may be accomplished by rendering the 3D world from a single (monoscopic) viewpoint and projecting the resulting image onto a 3D surface, referred to herein the reprojection surface 106.

FIG. 1A depicts a side view of the user 102 wearing the VR headset 104 and viewing the reprojection surface 106 that reprojects the image of the objects 108 A, B, and C. The reprojection surface 106 may be positioned in front of a “virtual face” of the user 102 and may be the only thing the left and right virtual eyes of the user 102 actually see, as the reprojection surface 106 may be large enough that it occupies the entire field of view of the user 102, and the image (e.g., image 118 of FIG. 1B) projected onto the reprojection surface 106 may instantly reflect movements of the user 102 in the 3D environment 120 just like in typical real time VR experiences. The shape of the reprojection surface 106 may be spherical (or at least a portion of the interior of a sphere) to provide a uniform convergence distance across the entire field of view, and the projection technique used to render onto the surface may be performed in a manner that makes the surface itself undetectable to the user. For example, regardless of its shape, the projection surface may always occupy the entirety of the user's field of view such that the user never sees the “edge” of the projection surface. Consequently, there are no cues that the user is looking at a surface and not “into” the 3D world. Furthermore, the image projected on the surface closely approximates the “fused” image in the mind of the user that the user would expect from a traditional 3D VR.

Because a person's body is never completely still no matter how still the person tries to be, the continuous micro-movements of the user provide an endless stream of parallax depth cues as the environment image projected constantly changes. This contrasts the experience in traditional gaming and film where is technically possible for the camera and environment to be perfectly static, resulting in a static image overtime.

Note that the reprojection surface 106 is not required to be spherical or a portion of the interior of a sphere, however, but may be of any curvature, such as the outer or inner surface of a non-spherical spheroid or even flat. It is also contemplated that in some embodiments the reprojection surface 106 need not be smooth, but may have surface textures, holes, bumps, indentations, or other surface variances as needed for a particular embodiment. A vector from the viewpoint of a virtual camera representing the viewpoint of the user 102 to the reprojection surface may be normal (geometrically) to the reprojection surface 106 at a point on the reprojection surface 106, or, alternatively, may not be normal at any point on the reprojection surface 106. For example, in some cases the reprojection surface 106 may be tilted away from the virtual camera in some manner, although in this example the tilted surface may no longer project a uniform convergence distance.

FIG. 1B depicts a perspective view from the perspective of a stereoscopic VR camera 114 situated at a virtual location occupied by the VR headset 104. The size and distance of the reprojection surface 106 from the head of the user 102 are determined based on the ideal convergence distance f for the user 102, and the projected image 118 applied to the reprojection surface 106 may be adjusted such that the virtual environment 120 presented on the reprojection surface 106 may be mapped properly as if the user 102 was positioned directly within the 3D virtual environment 120. That is, the object projected on the reprojection surface is modified such that it appears to the user as if it were in the actual 3D position of the object in the 3D environment. In the virtual environment 120, object A is illustrated to be the closest of the objects 108 to the virtual position of the user 102 and object C is farthest of the objects 108 to the virtual position of the user 102. However, the stereoscopic vision of the user 102 ultimately sees only the reprojection surface 106 which has the effect of fixing all virtual objects 108 in the scene at focal distance f, regardless of any individual object's distance with respect to the virtual camera 114 that captured the scene. It may be essentially imperceptible to the user 102 that their view is actually of a singular image projected onto a surface, as opposed to the standard VR model of seeing a unique view of the 3D environment 120 with each eye. This imperceptibility may be due in no small part to physical sensitivity of VR headsets, as each micromovement of the actual head of the user 102 causes an instantaneously detectable change in the view presented to the user 102, thus preserving a strong sense of parallax between closer and further away objects 108 in the scene.

By analogy, this technology can be thought of as a virtual helmet the user 102 is wearing. Affixed to the outside of the virtual helmet may be a video camera 116 (e.g., a 3D simulation camera) that sees the world around it, inside the virtual helmet may be a video display (the reprojection surface 106) that occupies the wearer's entire field of view, and displays the video captured by the affixed camera 116 in real-time. The objects 108 A, B, and Care in the 3D virtual environment 120 and within a view frustum 110 of the 3D simulation camera 116. The image 118 projected onto the internal display may be adjusted to mask away the shape of the display surface, making its existence essentially imperceptible to the user 102. In embodiments, the 3D simulation camera refers to a virtual camera that captures a view of the virtual environment from two viewpoints spaced apart in the virtual environment by a distance approximating an average interpupillary distance between human eyes.

With this model the user 108 is ultimately seeing a stereoscopic view of a monoscopic image projected onto the inside of the virtual helmet. If users were to have convergence deficiency, this virtual helmet would be physically large, and thus the viewing surface would be far from their face. In case of a user with convergence excess, the virtual helmet would be physically small and thus the viewing surface would be closer to their face. In all cases the image 118 projected onto the surface may be adjusted so that the scene being viewed is mapped exactly as if the user 102 were standing in the 3D scene 120 at the same point as the virtual camera 114. For example, a 1×1 cube, positioned 2 meters in front of the virtual camera 114 would appear on the reprojection surface 106 such that it occupies the same amount of the user's field of view regardless of whether or not the reprojection surface 106 was small and close, or large and distant. Neither user would be able to tell that they are seeing the 3D environment 120 via this virtual helmet, as it occupies their entire field of view, and because the image 118 rendered on the reprojection surface 106 for each may be properly projected such that their sense of presence and positioning within the virtual environment 120 may be identical. In fact, the action of changing the size of the virtual helmet in real-time may be unnoticed by the user 102, other than at some point it may be more or less difficult to fixate on the image 118 as the size changes and their vision may “split” if the reprojection surface 106 is brought too close for the user 102 to focus on. Adjusting the size of this virtual helmet may be analogous to moving closer or further from a television (TV) screen to get a clearer view of the screen based on one's eyesight. In real life a user moving farther away from the TV would see a “smaller” version of the image on screen, and users moving closer would see a “larger” image. In VR, the system of the present disclosure has the advantage of preserving the size of the virtual imagery the user 102 sees, while only adjusting the vergence distance required to see the image 118 clearly. It is as if the TV could adjust instantly both its physical size, and the size of the image displayed on it as the user moved closer or further from the screen.

Thus, the techniques of the present disclosure mitigate discomfort related to fixating the eyes to perceive two images of a rendered object as single and when adjusting fixation from close objects to distant objects in the rendering, because by setting the correct convergence distance(s) f, no cross-eye adjustment should be required, thereby reducing muscle strain. Further, the approach described herein should likewise have a positive impact on binocular fusion.

In 3D environments, unlike in the real world, the eyes have to focus and fixate at different distances in VR, which can result in a “vergence-accommodation conflict,” where this type of unnatural eye fixation causes additional discomfort to the user. The solution of the present disclosure solves this conflict that occurs when the difference between the vergence and accommodation distances for a given user are large by unifying the vergence distance for all object in the 3d environment, and by allowing for the used to set vergence distance it may be made close to the accommodation distance minimizing the conflict.

Additionally, the techniques of the present disclosure solve the problem where adjusting vergence can be discomforting to the viewer if there are many rapidly moving objects in the scene by completely “flattening” the image onto the projection surface. This way, if the convergence distance f is set properly, the user should not need to adjust their eyes at all, and even at a non-ideal convergence distance, once the eyes of the user have converged, they do not need to re-converge at a new distance.

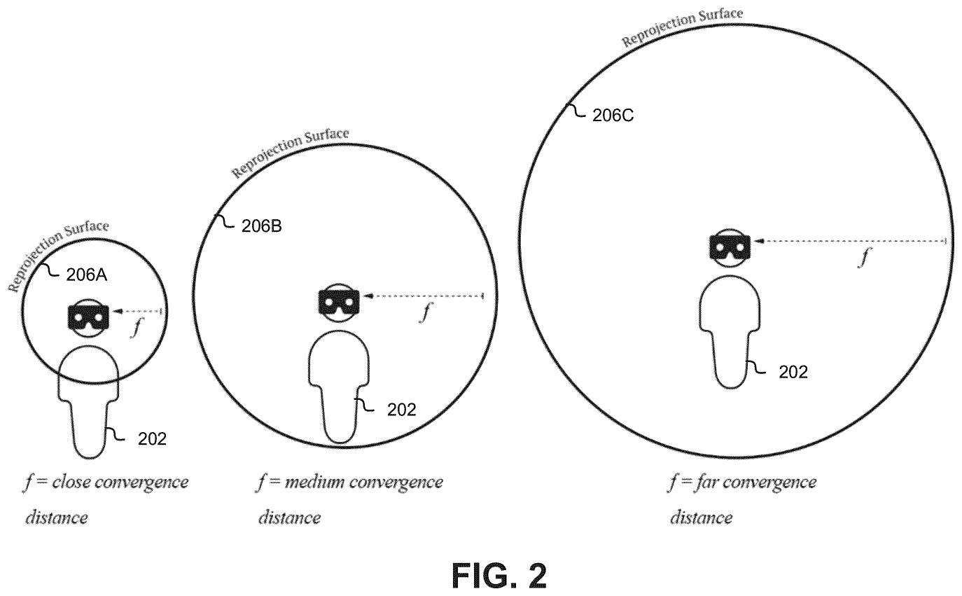

FIG. 2 illustrates multi-convergence distance; the techniques described in the present disclosure can be extended to support multiple discrete convergence distances simultaneously. This may be accomplished by partitioning the virtual world into “depth slices,” each at a different distance (or depth) from the virtual camera. A corresponding reprojection surface 206 exists for each depth slice, each also at a unique distance and size from the virtual face of a user 202. The camera renders each slice independently, only rendering pixels of objects that occupy the given slice, and the output render pass is applied to the corresponding reprojection surface 206 only. Functionally, objects rendered by the closest depth slice are projected onto the closest reprojection surface, and each deeper slice is projected onto the next furthest surface, with the process repeating for N slices. This technique may have the benefit of creating parallax without re-rendering. However, without re-rendering, near layers may look strange. In this embodiment, a reprojection surface at one discrete distance could project objects within a specific “near range” and another show objects (e.g., background objects) at a farther range.

Any pixel of the reprojection surface 206 that does not contain data for the current slice is not “drawn” and is left fully transparent, such that deeper reprojection surfaces are visible to the user at that point in their field of view. The width of each slice need not be uniform but may be. This method has the effect of fixing objects of varying distances from the camera to discrete vergence distances from the user. For example, a given slice corresponding to a range of 1 to 3 meters from the camera may be projected such that all pixels are fixated at 2 meters (f=close convergence distance), the next slice may correspond to object 3 to 5 meters (f=medium convergence distance), fixated at 4 meters, and everything 5 meters and beyond may be fixated to 6 meters (f=far convergence distance), respectively.

By presenting the entire scene in a single layer at a uniform convergence distance, the amount of work the eyes must do when shifting gaze between objects is significantly reduced. This technique also allows for “compressing the depth” of the scene into a desired range for comfortable viewing. By compressing the depth of foreground and background objects, the change in convergence of the eyes is reduced when shifting gaze between near and far objects-the amount of “cross-eye” needed is the same for all objects rendered in a given layer.

### 2. Solving the Post-Processing Problem

Post-processing refers to the various techniques and effects applied after a 3D scene is rendered. These techniques can be used to enhance visual quality, apply special effects, or manipulate the rendering to improve visual fidelity. Since stereo VR involves rendering two slightly different perspectives, it poses unique challenges for post-processing: in terms of proper alignment and consistency between the renderings for the two eyes, and in terms of processing power needed.

Using a properly projected view of the 3D world instead of a stereo image pair allows the system of the present disclosure to take advantage of all the post-processing techniques available for 2D media, while also reducing the computing power needed for post-processing by half. Rendering to a monoscopic projected view allows the system to easily apply special effects like “comic book rendering” at a much higher quality and without the inconsistencies that would result from applying such effects in a stereo VR setup.

The techniques of the present disclosure reduce the cost of post-processing in real time applications because post-processing in the present embodiments only need to be performed once, unlike twice for traditional regular VR applications. Likewise, because post-processing of the present disclosure only needs to be performed once, framerate “hiccups” or “hangs” are reduced, which can mitigate severe motion sickness potentially experienced by users.

Further, because the same final image is seen by both eyes in embodiments of the present disclosure, there is no discrepancy between the two eyes to impact intended “cartoon” effects, making the user feel immersed in a cartoon or comic book style world. Additionally, because the same final image is seen by both eyes, so there is no discrepancy between the two eyes to cause discomfort when viewing “shading” effects presented to each eye, which preserves the user's sense of immersion and maintains the developers' intention for the VR scene.

Still further, techniques of the present disclosure solve the problem of inconsistencies between two renderings in a stereo VR setup when detecting edges and sampling information from the rendered image by sampling from a single projected image, thereby eliminating the inconsistencies possible when sampling from two different eye images. In this manner, the user's sense of presence and the illusion of depth is maintained.

Note that, in the context of describing disclosed embodiments, unless otherwise specified, use of expressions regarding executable instructions (also referred to as code, applications, agents, etc.) performing operations that “instructions” do not ordinarily perform unaided (e.g., transmission of data, calculations, etc.) denotes that the instructions are being executed by a machine, thereby causing the machine to perform the specified operations.

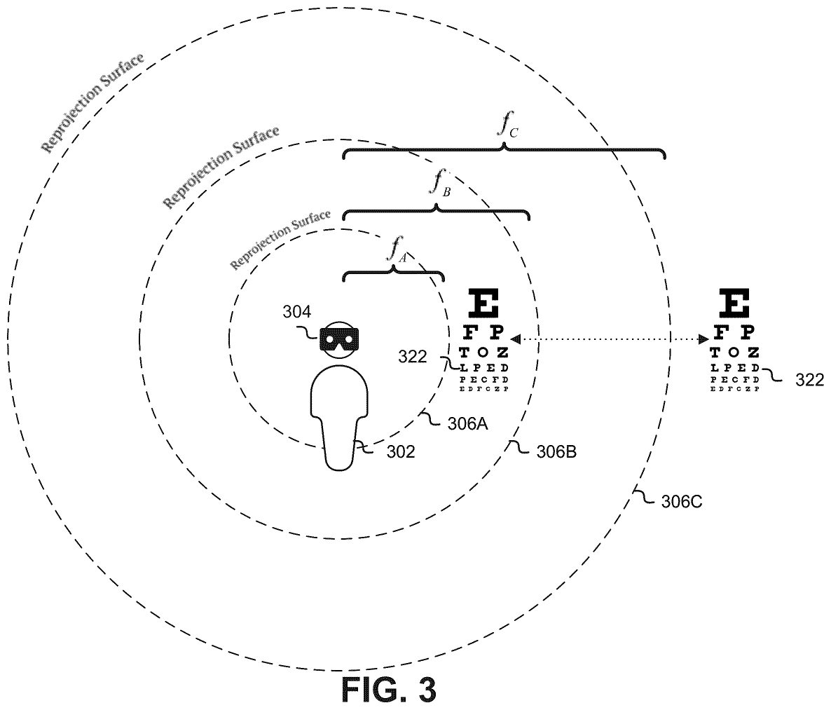

FIG. 3 illustrates an example of determining a convergence distance f in accordance with an embodiment of the present disclosure. Specifically, FIG. 3 depicts a user 302 wearing a VR headset 304 and experiencing a process of determining the convergence distance f for a virtual reprojection surface 306 based on when a virtual object 322 is in focus.

The user 302 may be an individual wearing the VR headset 304 or other device with a 3D display. The user 302 may have a vision disorder/deficiency, such as myopia (near-sightedness), hypermetropia (far-sightedness), astigmatism, presbyopia (age-related far-sightedness), or other vision disorder in one or both eyes. In some cases, the user 302 may have multiple vision disorders in one or both eyes. In some cases, the user 302 may have one or more different vision disorders in each eye. In some cases, the user 302 may wear corrective devices on or over the eyes, such as eyeglasses or contact lenses, for vision correction.

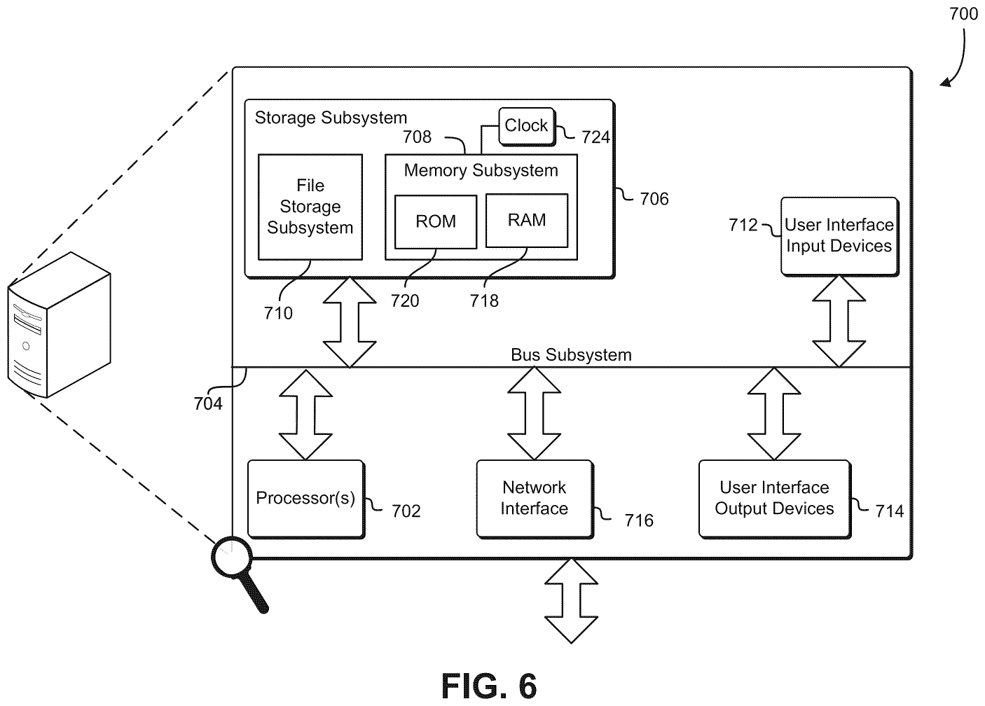

The VR headset 304 may be an electronic head-mounted display device that uses a pair of near-eye displays and/or positional tracking to provide a 3D virtual reality experience for the user 302. The VR headset 304 may be an electronic output device similar to the VR headset 104 of FIG. 1 for presentation of information in visual form via at least one electronic display (also referred to as a “screen”). The electronic display may be flat or curved and may be an electroluminescent display, liquid crystal display, a light-emitting diode display, a plasma display, a quantum dot display, an image projector, or other display suitable for presenting the visual information described by the present disclosure. The VR headset 304 may include one or more processors, one or more electronic visual displays, and display adapters. The VR headset 304 may be capable of wired or wireless network communications, such as support for Wi-Fi, cellular networking, or Bluetooth technology. The VR headset may include one or more of the capabilities of the system 600 of FIG. 6. The VR headset 304 may be a helmet, eyeglasses, or other device that presents a display to the user 302. The VR headset 304 may include a stereoscopic display that provides separate images for each eye of the user 302 or a monocular display that provides an image for one eye. In some embodiments, the VR headset 304 may include one or more sensors such as accelerometers and/or gyroscopes for tracking the pose of the head of the user 302 to match the orientation of a virtual camera with eye positions of the user 302 in the real world. In some embodiments, the VR headset 304 includes an eye-tracking sensor. In some embodiments, the VR headset 304 uses head-tracking and changes the field of vision as the user 302 turns their head. In some embodiments, the VR headset 304 may be an augmented reality headset that combines/overlays real-world image content with computer-generated 3D content.

Additionally or alternatively, the VR headset 304 may be a pair of eyeglasses in an active shutter system. In one such implementation, an image intended for a left eye of the user 302 may be presented while blocking a right eye of the user 302, and an additional image intended for the right eye of the user 302 may be presented while blocking the left eye of the user 302. This process may be repeated so rapidly in synchronization with the refresh rate of a display that the interruptions do not interfere with the user's perception of the two images as a single 3D image. Such glasses may contain a liquid crystal layer that has the property of becoming dark when voltage is applied, and transparent when voltage is not applied.

Additionally or alternatively, the VR headset 304 may be a pair of eyeglasses in a passive shutter system. In one such implementation, images for the right and left eyes may be projected superimposed on the display through polarizing filters or presented on a display with polarized filters. In some implementations, each row of pixels of the display is alternatively polarized for one or the other eye (in an interlaced manner). The eyeglasses may include a pair of opposite polarizing filters such that each filter only passes light that is similarly polarized and blocks the opposite polarized light. In this manner, each eye only sees one of the images and the 3D effect is achieved. It is contemplated that techniques of the present disclosure may be used with other types of passive 3D viewer technologies, such as interference filter systems, color anaglyph systems, chromadepth systems, and other systems.

The virtual object 322 may be an object usable for determining whether a rendering of the virtual object 322 in the VR headset 304 is in focus for the user 302. In the example of FIG. 3, the virtual object 322 is a virtual representation of a Snellen eye chart, but it is contemplated that the virtual object 322 may be any virtual object suitable for estimating visual acuity.

The virtual reprojection surfaces 306A-06B may be virtual projection surfaces at respective virtual distances f_{A}-f_{C}. In the example depicted in FIG. 3, the virtual object 322 may be virtually projected on one of the virtual reprojection surfaces (e.g., virtual reprojection surface 306A). The software application performing the process to determine the preferred convergence distance f may, as a result of being executed by one or more processors of a computer system (e.g., the VR headset 304 itself or other computer system in communication with the VR headset), cause the VR headset 304 to render the virtual object 322 on a first virtual reprojection surface 306A at a first distance f_{A}. Depending on feedback from the user 302 (such as input from the user 302 indicating that the virtual object 322 is or is not in focus or biometric, pupil response, eye movements, eye accommodation response, retinal imaging, squinting, and/or other feedback), the convergence distance f may be adjusted to a second distance (such as second distance f_{B}). The process may be repeated and, again, depending on feedback from the user 302, the convergence distance f may be adjusted to a third distance (such as second distance f_{C}), and feedback may be again obtained from the user 302. This process may continue until the feedback from the user 302 indicates that the virtual object 322 is sufficiently in focus for the user 302, and the convergence distance f at this point may be set.

In some embodiments, this process may be repeated separately for each eye of the user 302. In some embodiments, the process may include projecting the virtual object 322 on a reprojection surface at one distance f and then projecting the virtual object 322 on another reprojection surface at another distance f and obtaining feedback from the user 302 as to which projection was more in focus. This process may be repeated until the feedback from the user 302 indicates that the virtual object 322 is sufficiently in focus for the user 302, and the convergence distance f at this point may be set.

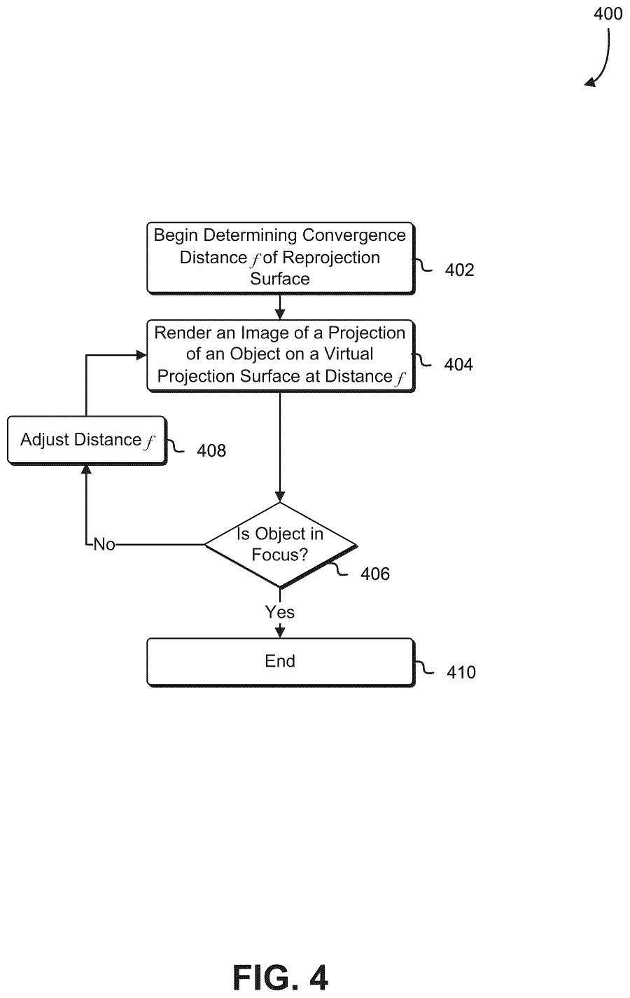

FIG. 4 is a flowchart illustrating an example of a calibration process 400 for determining the convergence distance f of a virtual reprojection surface from a user in accordance with various embodiments. Some or all of the calibration process 400 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media).

For example, some or all of calibration process 400 may be performed by any suitable system, such as a server in a data center, by various components of the system 600 described in conjunction with FIG. 6. In some embodiments, some, or all of the calibration process 400 is performed by a VR headset, such as the VR headset 104 of FIG. 1. In some embodiments, some or all of the calibration process 400 is performed by a separate computer system in communication (e.g., via Wi-Fi, Bluetooth, or other communication protocol) with the VR headset. The calibration process 400 includes a series of operations wherein an image of a virtual object is projected on a virtual surface at a prospective convergence distance f from a point of origin (e.g., a location of the user in a virtual environment), and the prospective convergence distance f is adjusted until the virtual object is determined to be focus. FIG. 3 provides an illustration of the calibration process 400.

In 402, the system performing the calibration process 400 begins the process to determine the preferred distance f for a virtual reprojection surface. The system may begin by setting distance f to a default value. The default value may be based on a convergence distance at which objects projected on the reprojection surface are in focus for a majority or plurality of users.

In 404, the system performing the calibration process 400 renders an image of the object at a virtual distance f on a virtual reprojection surface in a display of a device capable of conveying visual depth to a user, such as the VR headset 304 of FIG. 3. In some embodiments, the object is similar to the object 322. The object may be a representation of an object suitable for judging visual acuity, such as a Snellen chart, Landolt C, Golovin-Sivtsev table, Moyoner chart, or other object.

In 406, the system performing the calibration process 400 obtains feedback from a user (e.g., the user 302 of FIG. 3). In some embodiments, the feedback may be a binary (e.g., yes/no, true/false, etc.) response by the user indicating whether the object is in focus or not. In some embodiments, the feedback may be whether the focus of the object displayed is “better” or “worse” than a previously displayed rendering of the object at a different distance f. In some embodiments, one or more sensors may be used to measure the viewing distance of the user.

If the object is not determined to be in focus for the user, the system performing the process may proceed to 408. In 408, the system performing the calibration process 400 adjusts the convergence distance f and proceeds to repeat 404. For example, if the user indicated in 406 that the focus of the object at a current distance f was “worse” than at a previous distance f, the convergence distance f may be adjusted to be nearer to the previous distance f than the current distance f. Likewise, if the user indicated in 406 that the focus of an object at the current distance f is “better” than at a previous distance f, then the convergence distance f may be adjusted to some distance nearer to the current distance f than the previous distance f.

Otherwise, if the object is determined to be in focus for the user, the system performing the process may proceed to 410. In 410, the system performing the calibration process 400 determines that the most recent distance f is the preferred distance for the virtual reprojection surface. In this way, the convergence distance f can be fine-tuned individually for each user. For VR headsets that are difficult, incompatible, or uncomfortable to use while wearing eyeglasses or other visual correction devices, the techniques of the present disclosure may enable users with visual disorders/impairment to experience virtual reality without needing their visual correction device(s) by presenting the image at a convergence distance f that is not significantly affected by the user's visual disorder(s)/impairment(s). Rendering the images on the reprojection surface thereby mitigates/offsets the effects of the user's visual disorder(s)/impairment(s) on the user's ability to view virtual environment such that the user 102 may not need to wear visual correction device(s) while using the VR headset 104.

Further, even users without visual disorders/impairment may vary in their visual acuity and may benefit from fine-tuning the convergence distance f for better focus in the VR environment. Note that the operations 402-10 may be performed for each eye separately or for both eyes at the same time. Note also that one or more of the operations performed in 402-10 may be performed in various orders and combinations, including in parallel.

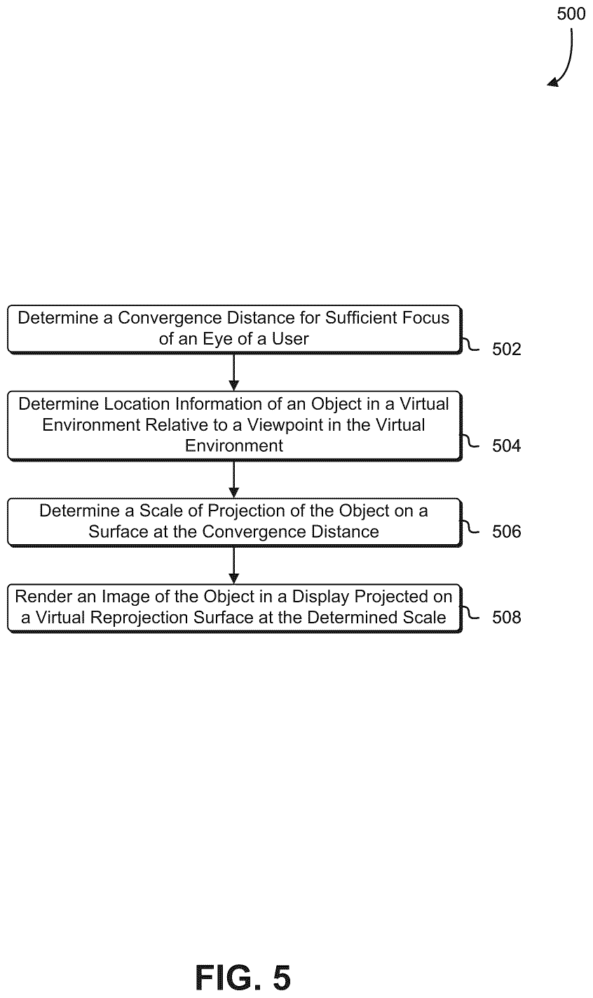

FIG. 5 is a flowchart illustrating an example of a process 500 for improving a visual experience of a user viewing a virtual reality display device in accordance with various embodiments. Some or all of the process 500 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media).

For example, some or all of process 500 may be performed by any suitable system, such as a server in a data center, by various components of the system 600 described in conjunction with FIG. 6. In some embodiments, some, or all of the process 500 is performed by a VR headset, such as the VR headset 104 of FIG. 1. In some embodiments, some or all of the process 500 is performed by a separate computer system in communication (e.g., via Wi-Fi, Bluetooth, or other communication protocol) with the VR headset. The process 500 includes a series of operations wherein location of a virtual object in a virtual environment relative to the viewer is determined, a convergence distance for a reprojection surface is determined, the virtual object is projected on the reprojection surface at the convergence distance, and the image is rendered on a display of a user device.

In 502, the system performing the process 500 determines a convergence distance for a user using a virtual reality display device, such as the VR headset 104. The convergence distance may be a distance from a viewpoint of an eye of the user to a location in a virtual environment at which to place the reprojection surface. The calibration process 400 of FIG. 4 provides an example of determining a convergence distance.

In 504, the system performing the process 500 determines location information of a virtual object in a virtual environment within the field of view (view frustum) of a virtual camera. The virtual camera may have a field of view (FoV) that mimics the range of vision of a human eye. The virtual camera may be positioned and oriented in the virtual environment to align with the eye of the user. In embodiments, there may be two virtual cameras—one for each eye—spaced apart to match an average interpupillary distance between human eyes to create a stereoscopic 3D effect. In embodiments, the virtual reality display device uses head tracking technology to continuously monitor the position and orientation of the user's head in real-time. This head tracking data may be used to dynamically adjust the virtual camera's position and orientation to match the user's head movements so as to maintain the illusion that the user is present within the virtual world.

In 506, the system performing the process 500 computes how the mapping and perspective of the virtual object needs to be adjusted when the virtual object is rendered in 2D on the reprojection surface. This adjustment may be similar to what happens in a regular 3D “camera to screen transformation” except that the reprojection surface of the present disclosure is not necessarily flat, so the system may apply a distortion that hides this from the user from their specific point of view. By performing this computation in real-time in conjunction with 508, the user may be unaware that virtual object is being projected onto the reprojection surface at all.

In 508, the system performing the process 500 renders a 2D image of the virtual object on the reprojection surface at the convergence distance f. In this manner, when the image is displayed on a display of the virtual reality display device, it is not only located at a preferred focal depth for the user's eye, which additionally may reduce potential eyestrain, but may also appear to be a 3D object when coupled with another display of the virtual reality display device for the user's other eye (stereoscopic effect). Note that one or more of the operations performed in 502-08 may be performed in various orders and combinations, including in parallel.

FIG. 6 below is an illustrative, simplified block diagram of a computing device 600 that can be used to practice at least one embodiment of the present disclosure. In various embodiments, the computing device 600 includes any appropriate device operable to send and/or receive requests, messages, or information over an appropriate network and convey information back to a user of the device. The computing device 600 may be used to implement any of the systems illustrated and described above. For example, the computing device 600 may be configured for use as a VR headset, a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 600 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 6 below, the computing device 600 may include one or more processors 602 that, in embodiments, communicate with and are operatively coupled to a number of peripheral subsystems via a bus subsystem. In some embodiments, these peripheral subsystems include a storage subsystem 606, comprising a memory subsystem 608 and a file/disk storage subsystem 610, one or more user interface input devices 612, one or more user interface output devices 614, and a network interface subsystem 616. Such storage subsystem 606 may be used for temporary or long-term storage of information.

In some embodiments, the bus subsystem 604 may provide a mechanism for enabling the various components and subsystems of computing device 600 to communicate with each other as intended. Although the bus subsystem 604 is shown schematically as a single bus, alternative embodiments of the bus subsystem utilize multiple buses. The network interface subsystem 616 may provide an interface to other computing devices and networks. The network interface subsystem 616 may serve as an interface for receiving data from and transmitting data to other systems from the computing device 600. In some embodiments, the bus subsystem 604 is utilized for communicating data such as details, search terms, and so on. In an embodiment, the network interface subsystem 616 may communicate via any appropriate network that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UpnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering. Many protocols and components for communicating via such a network are well-known and will not be discussed in detail. In an embodiment, communication via the network interface subsystem 616 is enabled by wired and/or wireless connections and combinations thereof.

In some embodiments, the user interface input devices 612 include one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 600. In some embodiments, the one or more user interface output devices 614 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 600. The one or more user interface output devices 614 can be used, for example, to present user interfaces to facilitate user interaction with applications performing processes described and variations therein, when such interaction may be appropriate.

In some embodiments, the storage subsystem 606 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 606. These application modules or instructions can be executed by the one or more processors 602. In various embodiments, the storage subsystem 606 additionally provides a repository for storing data used in accordance with the present disclosure. In some embodiments, the storage subsystem 606 comprises a memory subsystem 608 and a file/disk storage subsystem 610.

In embodiments, the memory subsystem 608 includes a number of memories, such as a main random-access memory (RAM) 618 for storage of instructions and data during program execution and/or a read only memory (ROM) 620, in which fixed instructions can be stored. In some embodiments, the file/disk storage subsystem 610 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 600 includes at least one local clock 624. The at least one local clock 624, in some embodiments, is a counter that represents the number of ticks that have transpired from a particular starting date and, in some embodiments, is located integrally within the computing device 600. In various embodiments, the at least one local clock 624 is used to synchronize data transfers in the processors for the computing device 600 and the subsystems included therein at specific clock pulses and can be used to coordinate synchronous operations between the computing device 600 and other systems in a data center. In another embodiment, the local clock is a programmable interval timer.

The computing device 600 could be of any of a variety of types, including a portable computer device, tablet computer, a workstation, or any other device described below. Additionally, the computing device 600 can include another device that, in some embodiments, can be connected to the computing device 600 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 600 for processing. Due to the ever-changing nature of computers and networks, the description of the computing device 600 depicted in FIG. 6 below is intended only as a specific example for purposes of illustrating the preferred embodiment of the device. Many other configurations having more or fewer components than the system depicted in FIG. 6 below are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

In some embodiments, data may be stored in a data store (not depicted). In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object-level interfaces. The computing device 600 may include any appropriate hardware, software, and firmware for integrating with a data store as needed to execute aspects of one or more applications for the computing device 600 to handle some or all of the data access and business logic for the one or more applications. The data store, in an embodiment, includes several separate data tables, databases, data documents, dynamic data storage schemes, and/or other data storage mechanisms and media for storing data relating to a particular aspect of the present disclosure. In an embodiment, the computing device 600 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers or other network devices are stored locally and/or remotely, as appropriate.

In an embodiment, the computing device 600 may provide access to content including, but not limited to, text, graphics, audio, video, and/or other content that is provided to a user in the form of HyperText Markup Language (HTML), Extensible Markup Language (XML), JavaScript, Cascading Style Sheets (CSS), JavaScript Object Notation (JSON), and/or another appropriate language. The computing device 600 may provide the content in one or more forms including, but not limited to, forms that are perceptible to the user audibly, visually, and/or through other senses. The handling of requests and responses, as well as the delivery of content, in an embodiment, is handled by the computing device 600 using PHP: Hypertext Preprocessor (PHP), Python, Ruby, Perl, Java, HTML, XML, JSON, JavaScript, and/or another appropriate language in this example. In an embodiment, operations described as being performed by a single device are performed collectively by multiple devices that form a distributed and/or virtual system.

In an embodiment, the computing device 600 typically will include an operating system that provides executable program instructions for the general administration and operation of the computing device 600 and includes a computer-readable storage medium (e.g., a hard disk, random access memory (RAM), read only memory (ROM), etc.) storing instructions that if executed (e.g., as a result of being executed) by a processor of the computing device 600 cause or otherwise allow the computing device 600 to perform its intended functions (e.g., the functions are performed as a result of one or more processors of the computing device 600 executing instructions stored on a computer-readable storage medium).

In an embodiment, the computing device 600 operates as a web server that runs one or more of a variety of server or mid-tier applications, including Hypertext Transfer Protocol (HTTP) servers, FTP servers, Common Gateway Interface (CGI) servers, data servers, Java servers, Apache servers, and business application servers. In an embodiment, computing device 600 is also capable of executing programs or scripts in response to requests from user devices, such as by executing one or more web applications that are implemented as one or more scripts or programs written in any programming language, such as Java®, C, C #or C++, or any scripting language, such as Ruby, PHP, Perl, Python, JavaScript, or TCL, as well as combinations thereof. In an embodiment, the computing device 600 is capable of storing, retrieving, and accessing structured or unstructured data. In an embodiment, computing device 600 additionally or alternatively implements a database, such as one of those commercially available from Oracle®, Microsoft®, Sybase®, and IBM® as well as open-source servers such as MySQL, Postgres, SQLite, MongoDB. In an embodiment, the database includes table-based servers, document-based servers, unstructured servers, relational servers, non-relational servers, or combinations of these and/or other database servers.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values in the present disclosure are merely intended to serve as a shorthand method of referring individually to each separate value falling within the range unless otherwise indicated, and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention, and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

1. A computer-implemented method, comprising:
determining a convergence distance from a viewpoint of a virtual camera in a three-dimensional (3D) virtual environment where a reprojection surface is to be located relative to the virtual camera;
obtaining location information of a virtual object in the 3D virtual environment;
generating, based on the convergence distance and the location information of the virtual object relative to a position and orientation of the virtual camera, a two-dimensional (2D) image that includes the virtual object projected on the reprojection surface; and
rendering the 2D image in an electronic visual display.

2. The computer-implemented method of claim 1, wherein the electronic visual display is one of a pair of near-eye displays of a stereoscopic electronic head-mounted display device.

3. The computer-implemented method of claim 1, wherein the reprojection surface is curved.

4. The computer-implemented method of claim 3, wherein the reprojection surface is at least a portion of an interior of a sphere centered at the viewpoint.

5. A system, comprising:
one or more processors; and
memory including computer-executable instructions that, if executed by the one or more processors, cause the system to:
determine a distance from a viewpoint of a virtual camera to a projection surface in a virtual environment at which objects projected on the projection surface are in clearer focus for a user than at another distance from the viewpoint of the virtual camera;
obtain a location of an object in the virtual environment; and
project, based on the distance and the location, an image that includes the object onto the projection surface.

6. The system of claim 5, wherein the projection surface comprises at least a portion of an interior of a spheroid surrounding the virtual camera.

7. The system of claim 5, wherein the virtual environment is three-dimensional.

8. The system of claim 5, wherein the location is within a view frustum of the virtual camera.

9. The system of claim 5, wherein the projection surface occupies an entire field of view of the virtual camera.

10. The system of claim 5, wherein the computer-executable instructions further include executable instructions that further cause the system to cause the image to be displayed on a display of a stereoscopic display device.

11. The system of claim 10, wherein the stereoscopic display device is head-mounted.

12. The system of claim 10, wherein the computer-executable instructions further include instructions that further cause the system to:
project an additional image to be projected onto an additional projection surface located at a different distance from the viewpoint of the virtual camera; and
cause the additional image to be displayed on an additional display of the stereoscopic display device.

13. A non-transitory computer-readable storage medium storing thereon executable instructions that, if executed by one or more processors of a computer system, cause the computer system to at least:
determine a distance from a viewpoint of a camera in a virtual environment where a projection surface is to be located relative to the camera;
obtain a location of an object within a view frustum of the camera in the virtual environment;
generate, based on the distance and the location of the object relative to a position and orientation of the camera, an image that includes the object projected on the projection surface; and
render the image in an electronic display.

14. The non-transitory computer-readable storage medium of claim 13, wherein the projection surface is curved.

15. The non-transitory computer-readable storage medium of claim 13, wherein the executable instructions that cause the computer system to determine the distance includes instructions that cause the computer system to determine, based on feedback from a user of the electronic display, the distance at which objects projected on the projection surface are of acceptable visual acuity to the user.

16. The non-transitory computer-readable storage medium of claim 15, wherein the image projected on the projection surface offsets a vision deficiency of the user when the image.

17. The non-transitory computer-readable storage medium of claim 13, wherein the electronic display is a display in a stereoscopic display device.

18. The non-transitory computer-readable storage medium of claim 17, wherein the stereoscopic display device is a virtual reality headset.

19. The non-transitory computer-readable storage medium of claim 13, wherein the executable instructions further include instructions that further cause the computer system:
determine an additional distance from an additional viewpoint of an additional camera in the virtual environment where an additional projection surface is to be located relative to the additional camera;
generate, based on the additional distance and the location of the object relative to an additional position and orientation of the additional camera, an additional image that includes the object projected on the additional projection surface; and
render the additional image in an additional electronic display.

20. The non-transitory computer-readable storage medium of claim 19, wherein the electronic display and the additional electronic display are a pair of separate displays of a stereoscopic display device.
